(19) United States
(12) Patent Application Publication
(10) Pub. No.: US 2024/0253660 A1
(43) Pub. Date: Aug. 1, 2024

(54) BUILDING AND TRAINING A LANELET CLASSIFICATION SYSTEM FOR AN AUTONOMOUS VEHICLE

(71) Applicant: GM Global Technology Operations LLC, Detroit, MI (US)

(72) Inventors: Guangyu Jeff Zou, Warren, MI (US); Brent Navin Roger Bacchus, Sterling Heights, MI (US); Michael Alan Losh, Rochester Hills, MI (US); Indranil Palit, Rochester Hills, MI (US)

(21) Appl. No.: 18/161,954

(22) Filed: Jan. 31, 2023

(51) Int. Cl. B60W 60/00

(52) U.S. Cl. CPC B60W 60/001; B60W 2552/53

(57) ABSTRACT

A lanelet classification system for an autonomous vehicle includes one or more controllers including a classifier having a neural network that classifies lanelets of a lane graph structure based on one or more lane attributes. In one embodiment, the one or more controllers execute instructions to build the neural network. In another embodiment, the one or more controllers train the neural network to classify each lanelet of the lane graph structure.

### INTRODUCTION

The present disclosure relates to building a neural network that is part of a lane segment or lanelet classification system for an autonomous vehicle. The present disclosure is also directed towards training the neural network of the lanelet classification system.

An autonomous driving system for a vehicle is a complex system that includes many different aspects. For example, an autonomous driving system may include multiple sensors to gather perception data with respect to the vehicle's surrounding environment. The autonomous driving system may build a lane graph structure composed of a plurality lane segments that are homogeneous in driving-related characteristics. Some examples of driving-related characteristics include, but are not limited to, the type of paint markings at an edge of the lane, the number of adjacent lanes, and/or the presence of specific proscriptive markings such as turn arrows. The lane segments, which are also referred to as lanelets, are based on the perception data collected by the sensors as well as map data. A lanelet represents a single interconnectable lane segment and is classified based on one or more lane attributes. The lane attributes represent one or more permitted maneuvers associated with a subject lanelet such as, but not limited to, straight, turn left, turn right, bi-directional, split, parking, straight-plus-left, straight-plus-right, and non-drivable.

A lanelet classification model classifies each lanelet into one or more specific lane attributes based on one or more machine learning techniques. Specifically, before classifying the lanelets, the lanelet classification model is first trained using training data obtained from the perception data. The sensors collect the perception data during real-life driving events. However, labeling the training data is a manual process that is performed by one or more individuals, and may be cumbersome and time consuming. Furthermore, the data samples that are part of the training data may be unbalanced and dominated by only a few specific driving scenarios. For example, a majority of the data samples may be collected during highway driving and does not include many examples of driving in a city or urban area.

Thus, while autonomous driving systems achieve their intended purpose, there is a need in the art for an improved approach to train a lanelet classification model.

### SUMMARY

According to several aspects, a lanelet classification system for an autonomous vehicle is disclosed and includes one or more controllers including a classifier having a neural network that classifies lanelets of a lane graph structure based on one or more lane attributes. The one or more controllers execute instructions to build the neural network by determining a higher dimension feature for a plurality of local lanelets and a subject lanelet, where a spatial relationship exists between the subject lanelet and the local lanelets. The one or more controllers compute an attention score for each of the local lanelets based on the higher dimension feature, where the attention score indicates a weight value that the subject lanelet has on a particular local lanelet. The one or more controllers determine a normalized shared attention mechanism applicable to all of the local lanelets based on the attention score. The one or more controllers compute a transformed feature vector of the local lanelet based on the higher dimension feature and the normalized shared attention mechanism. Finally, the one or more controllers fuse the transformed feature vector for each of the local lanelet together to determine a single fused feature vector, where the single fused feature vector is input to build a subsequent layer of the neural network.

In another aspect, the spatial relationship indicates an upstream, downstream, left, and right relationship between the subject lanelet and the local lanelets.

In still another aspect, the higher dimension feature is determined based on:

$${z}_{i}^{( l )} = {W}^{( l )} {h}_{i}^{( l )}$$

where zᵢ^{(l)} is the higher dimension feature, hᵢ^{(l)} represents a set of node features that represent a summarization of local attributes of the local lanelets and the subject lanelet, and W^{(l)} represents a weight matrix.

In an aspect, the attention score is computed based on a nonlinear activation function.

In another aspect, the normalized shared attention mechanism is determined based on a normalization function that sums to 1.

In still another aspect, the transformed feature vector is determined based on:

$${h}_{i}^{* ( l )} = σ ( {\sum }_{j ∈ 𝒩 ( i )} {a}_{i j}^{( l )} {z}_{i}^{( l )} )$$

where h*ₗ^{(l)} represents the transformed feature vector, zᵢ^{(l)} is the higher dimension feature, [symbol] ₍ᵢ₎ represents a neighborhood of the particular local lanelet i, aᵢⱼ^{(l)} represents the normalized shared attention mechanism, and σ represents a nonlinear transform function.

In an aspect, the single fused feature vector is determined based on:

$${h}_{i}^{( i + 1 )} = {D}^{( l )} \cdot ( {‖}_{k = 0}^{3} {h}_{i}^{* ( l )} )$$

where hᵢ⁽ⁱ⁺¹⁾ represents the single fused feature vector, D^{(l)} represents a vector having the same length as the single fused feature vector hᵢ⁽ⁱ⁺¹⁾, and h*ᵢ^{(l)} represents the transformed feature vector.

In another aspect, the neural network of the classifier is a graph attention network.

In still another aspect, a lanelet classification system for an autonomous vehicle is disclosed, and includes one or more controllers including a classifier having a neural network that classifies lanelets of a lane graph structure based on one or more lane attributes. The one or more controllers execute instructions to receive simulated data, where the simulated data is a combination of map data and simulated perception data. The one or more controllers combine the simulated data with manual annotations that label the simulated perception data together to create a ground truth data set. The one or more controllers determine training data by mapping labels of one or more groups of labeled ground truth data points that are part of the ground truth data set to one or more groups of perturbed lane edge points that have been displaced from an original group of labeled ground truth data points to another group of labeled ground truth data points that are part of the ground truth data set. The one or more controllers train the neural network to classify each lanelet of the lane graph structure based on the training data.

In an aspect, the one or more controllers execute instructions to determine the neural network of the classifier is completely trained. In response to determining the neural network of the classifier is completely trained, the one or more controllers evaluate perception data generated by a plurality of sensors and the map data.

In another aspect, the one or more controllers execute instructions to identify an amount of overlap between a particular group of perturbed lane edge points and a particular group of labeled ground truth data points by calculating an intersection-over-union evaluation metric.

In still another aspect, the one or more controllers execute instructions to calculate the intersection-over-union evaluation metric based on:

$$IOU = \frac{\vert \{ P \vert P ∈ G {T}_{i} ⋂ {SEG}_{j} \} \vert}{\vert \{ P \vert P ∈ G {T}_{i} ⋃ {SEG}_{j} \vert}$$

where IOU is the intersection-over-union evaluation metric, SEGⱼ represents a particular group of perturbed lane edge points, GTᵢ represents a particular group of labeled ground truth data points, and P represents lane edge points expressed as a unique identification (ID) numbers.

In an aspect, the one or more controllers execute instructions to introduce noise to the simulated data to create noisy lanelet training samples.

In another aspect, the noise is modeled based on a variance profile of an error in a lane edge of the lane graph structure and a covariance.

In still another aspect, the error in the lane edge is modeled as a Gaussian Process, and wherein a kernel function models a spatial correlation of the error between two lane edge points.

In an aspect, a Matern 3/2 kernel function determines the variance profile.

In another aspect, the covariance is determined based on:

$$\sum = {S}^{1 / 2} C {S}^{1 / 2}$$

where Σ is the covariance, C is a correlation matrix, and S is a diagonal scale matrix.

In another aspect, the one or more controllers execute instructions to introduce occlusion features to the simulated data, wherein the occlusion features represent an occluded region of a roadway that the autonomous vehicle is traveling along.

In an aspect, a lanelet classification system for an autonomous vehicle is disclosed, and includes a plurality of sensors collecting perception data indicative of an environment surrounding the autonomous vehicle and one or more controllers in electronic communication with the plurality of sensors. The one or more controllers include a classifier having a neural network that classifies lanelets of a lane graph structure based on one or more lane attributes. The one or more controllers execute instructions to receive simulated data, wherein the simulated data is a combination of map data and simulated perception data. The one or more controllers combine the simulated data with manual annotations that label the simulated perception data together to create a ground truth data set. The one or more controllers introduce noise and occlusion features to the simulated data to create noisy lanelet training samples. The one or more controllers determine training data by mapping labels of one or more groups of labeled ground truth data points that are part of the ground truth data set to one or more groups of perturbed lane edge points the noisy lanelet training samples that have been displaced from an original group of labeled ground truth data points to another group of labeled ground truth data points that are part of the ground truth data set. The one or more controllers train the neural network to classify each lanelet of the lane graph structure based on the training data and the noisy lanelet training samples. The one or more controllers determine the neural network of the classifier is completely trained. Finally, in response to determining the neural network of the classifier is completely trained, the one or more controllers evaluate perception data generated by a plurality of sensors and the map data.

In another aspect, the one or more controllers execute instructions to identify an amount of overlap between a particular group of perturbed lane edge points and a particular group of labeled ground truth data points calculating an intersection-over-union evaluation metric.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic diagram of an autonomous vehicle including the disclosed lanelet classification system, where the lanelet classification system includes one or more controllers, according to an exemplary embodiment;

FIG. 2 is a block diagram of the one or more controllers shown in FIG. 1, according to an exemplary embodiment;

FIG. 3 is a block diagram of a ground truth mapper that is part of the one or more controllers shown in FIG. 2, according to an exemplary embodiment;

FIG. 4 is an illustration of an exemplary lane graph determined by the segmentation module shown in FIG. 2, according to an exemplary embodiment;

FIG. 5A is an illustration of the autonomous vehicle and one or more actors along a roadway, where an occluded region represents one or more areas along the roadway blocked from view by the one or more actors, according to an exemplary embodiment;

FIG. 5B is an illustration of a mask representing the occluded region illustrated in FIG. 5A and is expressed in polar coordinates, according to an exemplary embodiment;

FIG. 6 is a diagram of a lane graph structure where each lanelet includes one or more node features, according to an exemplary embodiment; and

FIG. 7 is a process flow diagram illustrating a method for training the lanelet classification system, according to an exemplary embodiment.

### DETAILED DESCRIPTION

The following description is merely exemplary in nature and is not intended to limit the present disclosure, application, or uses.

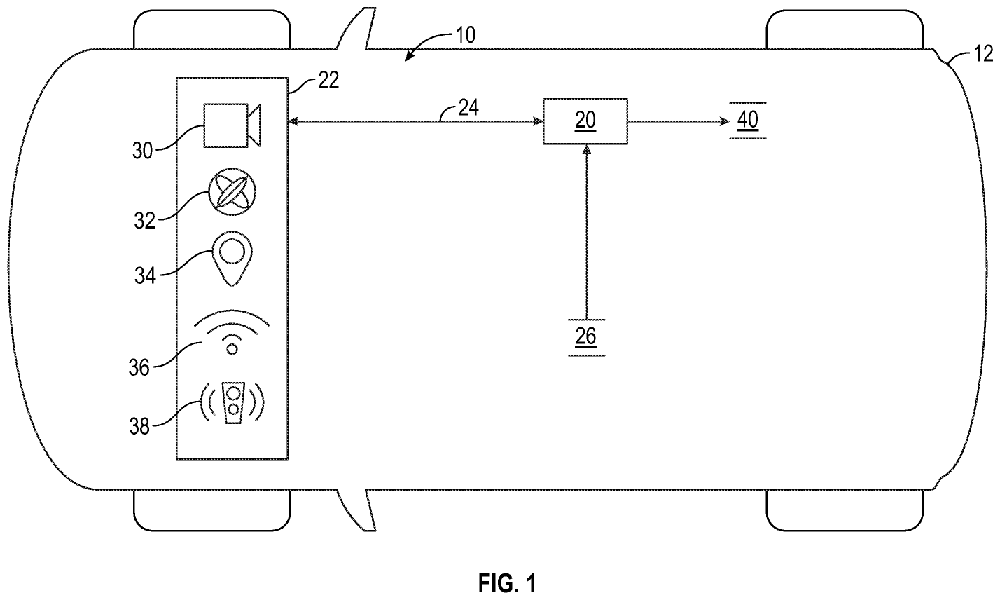

Referring to FIG. 1, an exemplary lane segment or lanelet classification system 10 for an autonomous vehicle 12 is illustrated. It is to be appreciated that the autonomous vehicle 12 may be any type of vehicle such as, but not limited to, a sedan, truck, sport utility vehicle, van, or motor home. The autonomous vehicle 12 may be a fully autonomous vehicle including an automated driving system (ADS) for performing all driving tasks or a semi-autonomous vehicle including an advanced driver assistance system (ADAS) for assisting a driver with steering, braking, and/or accelerating.

The lanelet classification system 10 includes one or more controllers 20 in electronic communication with a plurality of sensors 22 configured to collect perception data 24 indicative of an environment surrounding the autonomous vehicle 12. In the non-limiting embodiment as shown in FIG. 1, the plurality of sensors 22 include one or more cameras 30, an inertial measurement unit (IMU) 32, a global positioning system (GPS) 34, radar 36, and LiDAR 38, however, is to be appreciated that additional sensors may be used as well. In addition to receiving the perception data 24 from the plurality of sensors 22, the one or more controllers 20 also receives map data 26 as well. The perception data 24 from the plurality of sensors 22 indicates lane-level information regarding a roadway 14 that the autonomous vehicle 12 is traveling along. The map data 26 indicates road-level information of the roadway 14. The one or more controllers 20 recreate a scene of the environment surrounding the autonomous vehicle 12. The scene of the environment surrounding the autonomous vehicle is transmitted to an autonomous vehicle planner 40, which uses the scene for planning purposes.

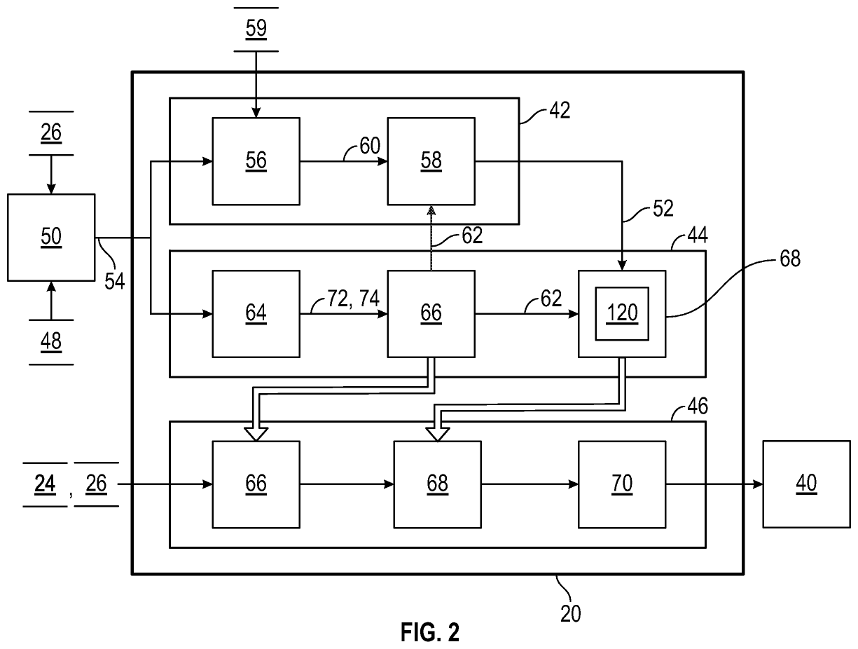

FIG. 2 is a block diagram of the one or more controllers 20 shown in FIG. 1. The one or more controllers 20 include a ground truth generation module 42, a training module 44, and an inference module 46. The ground truth generation module 42 includes an annotation block 56 and a ground truth mapper 58. The training module 44 includes an occlusion and noise block 64, a segmentation block 66, and a classifier 68. Both the ground truth generation module 42 and the training module 44 receive simulated data 54. The simulated data 54 is a combination of the map data 26 and simulated perception data 48 that is received from a simulator 50. Unlike the perception data 24, the simulated perception data 48 is not collected by the sensors 22 (FIG. 1). The simulated perception data 48 may be generated based on an idealized line-of-sight computation that considers an overall field-of-view in an angular extent and range in terms of distance from a simulated sensor. The simulated perception data 48 may also include possible occlusions from static and dynamic objects in a simulated driving scenario. In some embodiments, forms of noise such as, but not limited to, the detected position of an object, the object's detected appearance, and whether the object is detected or not, may be applied to simulate performance issues more realistically. In contrast, the inference module 46 of the one or more controllers 20 receives the perception data 24 generated by the plurality of sensors 22 (FIG. 1) and the map data 26.

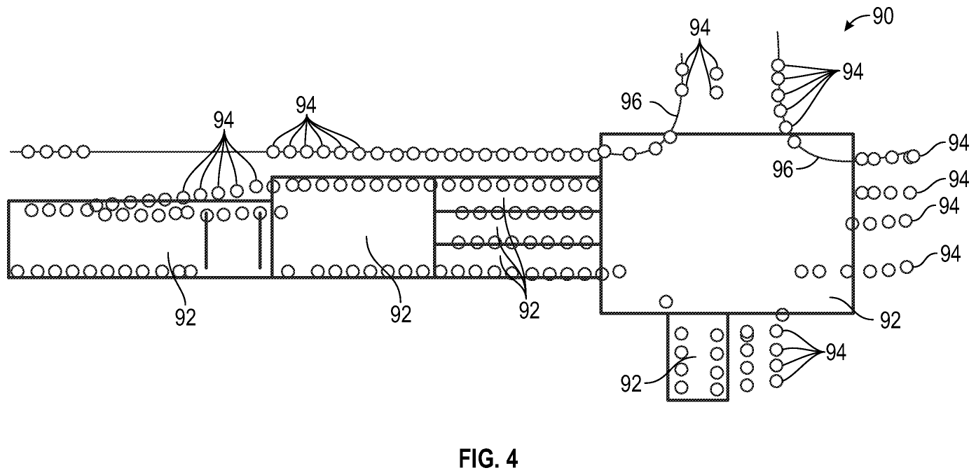

As explained below, the classifier 68 first builds a neural network 120 that classifies lanelets 92 that are part of a lane graph structure 90 (shown in FIG. 4). The classifier 68 then trains the neural network 120 based on the training data 52 received from the ground truth mapper 58 of the ground truth generation module 42 as well as simulated data 54 injected with noise 72 and occlusion features 74 by an occlusion and noise block 64. Once the neural network 120 is trained, the classifier 68 may then be used to evaluate real world data (i.e., the perception data 24 generated by the plurality of sensors 22) as part of the inference module 46. As seen in FIG. 2, the inference module 46 includes the segmentation block 66, the classifier 68 (which has been trained by the training module 44), and a scene builder 70 that sends the scene to the autonomous vehicle planner 40.

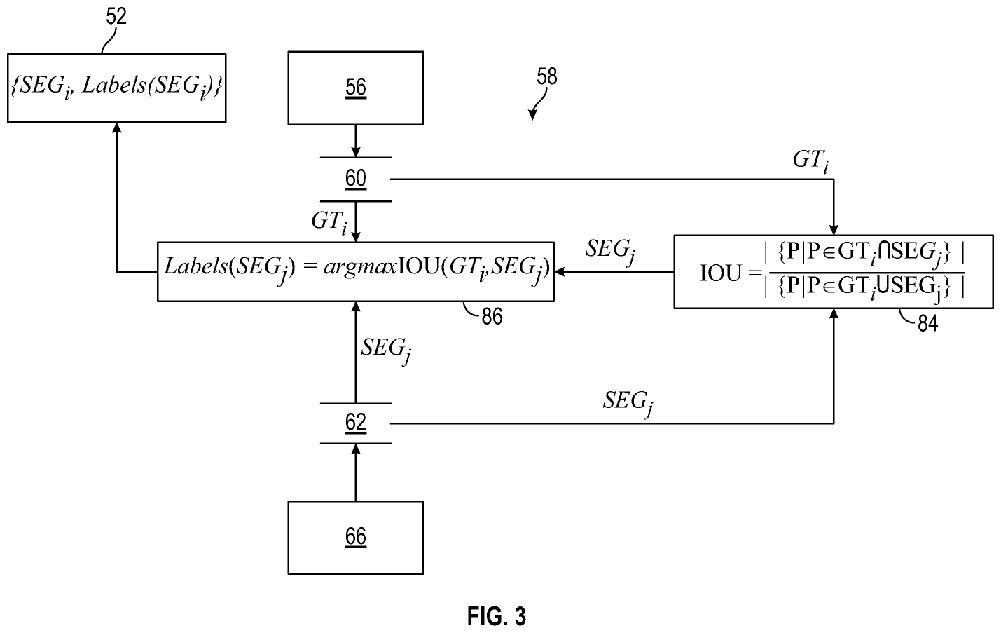

The annotation block 56 of the ground truth generation module 42 receives the simulated data 54 from the simulator 50 in combination with manual annotations 59 that label the simulated perception data 48, where the manual annotations 59 represent labels that are created by an individual. In other words, a person such as a subject matter expert creates the manual annotations 59. The annotation block 56 combines the simulated data 54 with the manual annotations 59 to create a labeled training data set, which is referred to as the ground truth data set 60. The ground truth data set 60 is transmitted to the ground truth mapper 58, which is shown in FIG. 3.

FIG. 4 illustrates an exemplary lane graph structure 90. The lane graph structure 90 is composed of the plurality of lanelets 92 and lane edge points 94, where the lanelets 92 are identified by the segmentation block 66 (FIG. 2). Referring to FIGS. 2, 3 and 4, the ground truth mapper 58 receives the ground truth data set 60 from the annotation block 56 and the noisy lanelet training samples 62 from the segmentation block 66. As explained below, the ground truth mapper 58 determines the training data 52 by mapping the labels (i.e., the manual annotations 59) of one or more groups of labeled ground truth data points GTᵢ that are part of the ground truth data set 60 to one or more groups of perturbed lane edge points SEGⱼ of the noisy lanelet training samples 62 that have been displaced from an original group of labeled ground truth data points GTᵢ by the noise 72 and the occlusion features 74 introduced into the simulated data 54 at the occlusion and noise block 64 (FIG. 2).

Referring to FIGS. 3 and 4, each training sample of the training data 52 includes a group of data points SEGᵢ that are part of the noisy lanelet training samples 62. Each group of data points SEGᵢ of the noisy lanelet training samples 62 are mapped to a corresponding group of labeled ground truth data points GTᵢ that is part of the ground truth data set 60, and a mapped label for the group of data points SEGᵢ is indicated as Labels(SEGᵢ) in FIG. 3. Each group of labeled ground truth data points GTᵢ represent the lane edge points 94 for one of the lanelets 92 of the lane graph structure 90 (shown in FIG. 4), where each lane edge point 94 is identified based on a unique identification (ID) number. The ground truth mapper 58 includes an identifier-based intersection-over-union block 84 and an arguments of the maxima (argmax) selector block 86. The group of data points SEGᵢ of the noisy lanelet training samples 62 from the segmentation block 66 includes one or more groups of perturbed lane edge points SEGⱼ that have been displaced from an original lanelet 92 and form another lanelet 92 due to the noise 72 and the occlusion features 74 injected into the system at the occlusion and noise block 64 (FIG. 2), which is described below. The one or more groups of perturbed lane edge points SEGⱼ are transmitted to the intersection-over-union identifier 82 and the argmax selector block 86.

The identifier-based intersection-over-union block 84 receives the one or more groups of labeled ground truth data points GTᵢ that have been extracted from the ground truth data set 60. The identifier-based intersection-over-union block 84 identifies an amount of overlap between a particular group of perturbed lane edge points SEGⱼ and a particular group of labeled ground truth data points GTᵢ when calculating an intersection-over-union evaluation metric. The intersection-over-union evaluation metric is expressed in Equation 1:

$$IOU = \frac{\vert \{ P \vert P ∈ G {T}_{i} ⋂ {SEG}_{j} \} \vert}{\vert \{ P \vert P ∈ G {T}_{i} ⋃ {SEG}_{j} \vert} \qquad Equation 1$$

where P represents the lane edge point 94 that are expressed as the unique ID numbers and IOU is the intersection-over-union evaluation metric that describes an extent of overlap between a particular group of perturbed lane edge points SEGⱼ and a particular group of labeled ground truth data points GTᵢ.

The identifier-based intersection-over-union block 84 transmits the amount of overlap between the particular group of perturbed lane edge points SEGⱼ and the particular group of labeled ground truth data points GTᵢ for each lanelet 92 of the lane graph structure 90 (FIG. 4) to the argmax selector block 86. The argmax selector block 86 then determines a selected group of labeled ground truth data points GTᵢ have the greatest number of lane edge points 94 that correspond to the perturbed lane edge points SEGⱼ. The perturbed lane edge points SEGⱼ represents a set of data points SEGᵢ that are part of the noisy lanelet training samples 62 representative of the lane edge points 94 that have been displaced from an original lanelet 92 and form another lanelet 92 that is subject to potential upstream degradation. The argmax selector block 86 then re-labels the selected group of perturbed lane edge points SEGⱼ as a group of group of data points SEGᵢ that correspond to a group of labeled ground truth data points GTᵢ, and is expressed in Equation 2 as:

$$Labels ( {SEG}_{j} ) = {arg max}_{i} IOU ( G {T}_{i} , {SEG}_{j} ) \qquad Equation 2$$

Referring back to FIG. 2, the training module 44 includes the occlusion and noise block 64, the segmentation block 66, and the classifier 68. The occlusion and noise block 64 introduces the noise 72 and the occlusion features 74 to the simulated data 54 received from the simulator 50. Although both noise 72 and occlusion features 74 are mentioned in combination with one another, it is to be appreciated that only the noise 72 or only the occlusion features 74 may be introduced to the simulated data 54. The noise 72 is modeled to represent variation and error that are observed with real-world map and perception data.

In one embodiment, the noise 72 is introduced by a noise vector injected into each training iteration of simulated data 54 from the simulator 50. In one non-limiting embodiment, the noise 72 is implemented as jitter. Referring to FIGS. 2 and 4, the noise 72 acts in a direction normal to each lane edge point 94 of the lane graph structure 90. Each lane edge point coordinate pᵢ is expressed as pᵢ=(pₓ, p_{y})ᵢ, so the instantaneous unit normal nᵢ is expressed as nᵢ=(nₓ, n_{y})ᵢ. Lane edges 96 are drawn based on the lane edge points 94. It is to be appreciated that the noise 72 is reduced based on any technique such as, for example, spline-based smoothing. Thus, the noise 72 is modeled based on smoothened error rather than original error.

The noise 72 is modeled based on a variance profile var(d) of an error in the lane edge 96 of the lane graph structure 90 (FIG. 4) and a covariance Σ, and d represents a longitudinal distance of the lane edge point 94 on the lane edge 96 under consideration. The error in the lane edge 96 is modeled as a Gaussian Process, where a kernel function k(x₁, x₂) models a spatial correlation of the error between two lane edge points 94, where k represents the kernel function and x₁, x₂ represent the two lane edge points 94. In one non-limiting embodiment, a Matern 3/2 kernel function and the variance profile var(d) are based on Equations 3, 4, and 5:

$$k ( {x}_{1} , {x}_{2} ) = ( 1 + \sqrt{3} \hat{d} ) exp ( - \sqrt{3} \hat{d} ) \qquad Equation 3$$

$$\hat{d} = \frac{‖ {x}_{1} - {x}_{2} ‖}{ρ} \qquad Equation 4$$

$$var ( d ) = {( {a}_{0} + {a}_{1} d )}^{2} \qquad Equation 5$$

where ρ represents a constant, and a₀ and a₁ represents constants. The variance profile var(d) indicates the variance of the error in the lane edge 96 created by the noise 72 is expressed as a function of distance.

An error eᵢ at the lane edge point coordinate pᵢ is expressed in Equation 6 as:

$${e}_{i} = ( {n}_{i} \cdot {w}_{i} ) {n}_{i} \qquad Equation 6$$

where wᵢ represents the zero mean Gaussian noise and is expressed in Equation 7 as:

$${w}_{i} ∼ N ( 0 , Σ ) \qquad Equation 7$$

The covariance Σ is determined based on a C correlation matrix and a diagonal scale matrix S, and is expressed in Equation 8 as:

$$Σ = {S}^{1 / 2} C {S}^{1 / 2} \qquad Equation 8$$

where the correlation matrix C is expressed in Equation 9 and the diagonal scale matrix S is represented in Equation 10.

$${C}_{i j} = [ k ( {p}_{i} , {p}_{j} ) ] \qquad Equation 9$$

$${S}_{i i} = [ var ( ‖ {p}_{i} ‖ ) ] \qquad Equation 10$$

where pᵢ, pⱼ represent the ith and jth lane edge point coordinates and ∥pᵢ∥ represents the distance to the point pᵢ.

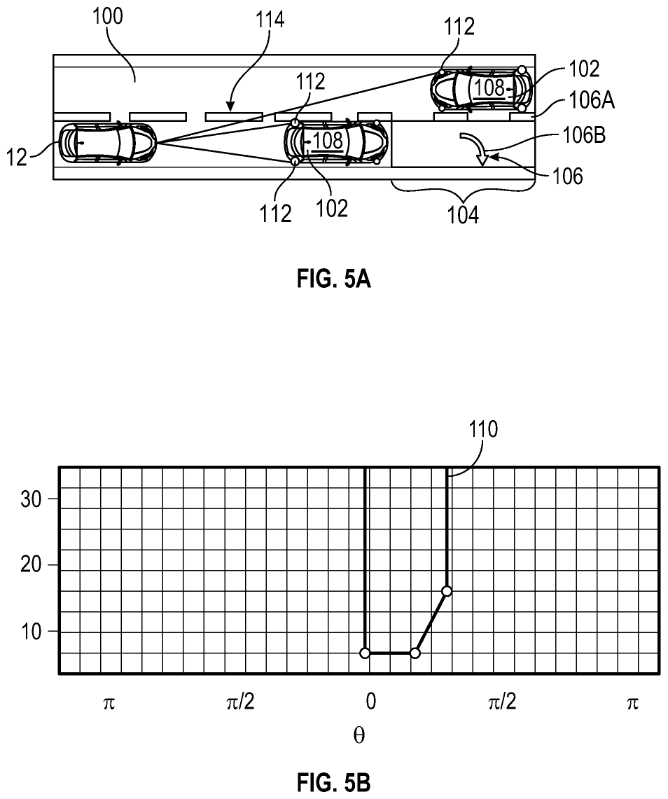

Referring to FIGS. 2 and 5A-5B, the occlusion features 74 are now described. The occlusion features 74 obscure specific areas of the lane edges 96 of the lane graph structure 90 (FIG. 4), which mimics real-world data where traffic participants may obscure lane markings. The occlusion features 74 represent an occluded region 104 of a roadway 100 that the autonomous vehicle 12 is traveling along. The occluded region 104 is blocked from view by one or more actors 102 located along the roadway 100. In the examples as shown in FIG. 5A, the one or more actors 102 block a portion of the roadway 100, thereby obscuring road markings 106 from view by the one or more sensors 22 (FIG. 1) that gather the perception data 24. In the example as shown, the road markings 106 include lane lines 106A and an arrow 106B, however, it is to be appreciated that the figures are merely exemplary in nature and other types of road markings 106 may be obscured as well. The occlusion and noise block 64 calculates a bounding box 108 that corresponds to each actor 102 along the roadway 100, as described above. The occlusion and noise block 64 then calculates two-dimensional corners 112 of each bounding box 108, where the two-dimensional corners 112 represent an edge of a corresponding bounding box 108. The occlusion and noise block 64 determines two-dimensional coordinates of the two-dimensional corners 112, and then converts the two-dimensional coordinates into polar coordinates (which are r and θ in the ego frame). The original two-dimensional coordinates may be expressed in either a world-referenced or an ego vehicle-referenced Cartesian (i.e., rectilinear) coordinate system.

As seen in FIG. 5B, the occlusion and noise block 64 then determines a mask 110 that represents the occluded region 104 of the roadway 100, where the mask 110 includes occluded regions 104 that overlap. The occluded regions 104 that overlap are caused by simple objects that are a geometrical union of the corresponding boundaries of the simple objects. Therefore, any corners of a particular object's occlusion boundary that falls within the occlusion boundary of a different object may be dropped from an overall boundary that is used to define the mask 110. The mask 110 is employed to omit lane edge points 94 (FIG. 4) and road markings 106 that are occluded by the one or more actors 102. In the event the occluded region 104 hides a middle portion 114 of the roadway 100 including the lane lines 106A, the lane lines 106A may be shortened or broken into multiple separate pieces.

Referring to FIG. 2, the segmentation block 66 receives the simulated data 54 that has been injected with the noise 72 and occlusion features 74 and identifies the lanelets 92 of the lane graph structure 90 (FIG. 4), where the lane graph structure 90 is included as part of the noisy lanelet training samples 62. The classifier 68 receives the noisy lanelet training samples 62 from the segmentation block 66 and transferred labels that are part of the training data 52 received from the ground truth mapper 58, and then trains a neural network 120 to classify each lanelet 92 of the lane graph structure 90 based on one or more lane attributes. The lane attribute represents one or more permitted maneuvers associated with each lanelet 92 such as, but not limited to, straight, turn left, turn right, bi-directional, split, parking, straight-plus-left, straight-plus-right, and non-drivable. Before training the neural network 120, the classifier 68 first builds the neural network 120 based on the lane graph structure 90 shown in FIG. 4. In one embodiment, the neural network 120 of the classifier 68 is a graph attention network, which operates on graph-structured data.

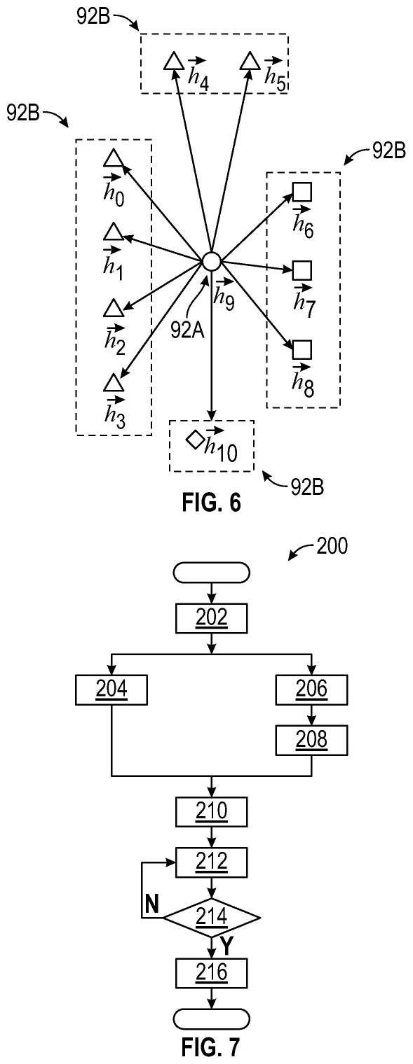

FIG. 6 is a block diagram of a subject lanelet 92A and a group of local lanelets 92B that surround the subject lanelet 92A. A four-way spatial relationship exists between the subject lanelet 92A and the four types of local lanelets 92B, where the spatial relationship indicates the orientation of one of the local lanelets 92B relative to the subject lanelet 92A. In the embodiment as shown, the spatial relationship indicates an upstream, downstream, left, and right relationship between the subject lanelet 92A and a particular local lanelet 92B. An upstream relationship refers to a lanelet 92 prior to the current lanelet 92, i.e. earlier in the flow of traffic; conversely, a downstream relationship refers to a lanelet 92 reached in the future; e.g., where traffic is flowing. Each lanelet 92 includes one or more node features \vec{hₙ}. For example, in the embodiment as shown in FIG. 6, the subject lanelet 92A includes node feature \vec{h₉}.

Referring to both FIGS. 2 and 6, the classifier 68 builds the neural network 120 one layer at a time, where an output of each layer of the neural network 120 is built by fusing together transformed feature vectors h*ᵢ^{(l)} for each of the local lanelets 92B of the subject lanelet 92A. In one embodiment, the transformed feature vectors h*ᵢ^{(l)} for each of the local lanelets 92B of the subject lanelet 92A are concatenated. An approach for building the neural network 120 by the classifier 68 is now described. The classifier 68 first determines a higher dimension feature zᵢ^{(l)} for all of the local lanelets 92B of the subject lanelet 92A and the subject lanelet 92A itself based on a set of node features hᵢ^{(l)} and a weight matrix W^{(l)}, where the set of node features hᵢ^{(l)} represent a summarization of local attributes of the local lanelets 92B, including the subject lanelet 92A itself. The higher dimension feature zᵢ^{(l)} for each of the local lanelets 92B is determined based on Equation 11 as:

$${z}_{i}^{( l )} = {W}^{( l )} {h}_{i}^{( l )} \qquad Equation 11$$

The classifier 68 then computes an attention score eᵢⱼ^{(l)} for each of the local lanelets 92B based on the higher dimension feature zᵢ^{(l)}, where the attention score eᵢⱼ^{(l)} indicates a weight value that the subject lanelet 92A has on a particular local lanelet 92B. The attention score eᵢⱼ^{(l)} is computed based on a nonlinear activation function. In one embodiment, the nonlinear activation function is a Leaky Rectified Linear Unit function, and the attention score eᵢⱼ^{(l)} is expressed in Equation 12 as:

$${e}_{i j}^{( l )} = Leaky ReLU ( {\vec{a}}^{{( l )}^{T}} ( {z}_{i}^{( l )} ‖ {z}_{j}^{( l )} ) ) \qquad Equation 12$$

where zᵢ^{(l)}, zⱼ^{(l)} represent the higher dimension features for the subject lanelet 92A and the particular local lanelet, respectively, and \vec{a}⁽¹⁾^{^{T}} represents a set of learnable parameters of a shared attention mechanism.

The classifier 68 then determines a normalized shared attention mechanism aᵢⱼ^{(l)} that is applicable to all of the local lanelets 92B that are part of a specific orientation group based on the attention score eᵢⱼ^{(l)} by a normalization function. In one embodiment, the normalization function is a softmax function that turns a vector of k real values into a vector of k real values that sum to 1. The normalized shared attention mechanism aᵢⱼ^{(l)} is determined based on Equation 13 as:

$${a}_{i j}^{( l )} = soft {max}_{j} ( {e}_{i j} ) \frac{exp ( {e}_{ij}^{( l )} )}{{Σ}_{j ∈ 𝒩 ( i )} {a}_{ij}^{( l )} {z}_{j}^{( l )}} \qquad Equation 13$$

where N₍ᵢ₎ represents a neighborhood of the particular local lanelet i of the specific orientation group.

The classifier 68 then computes a transformed feature vector h*ᵢ^{(l)} of the subject lanelet 92A based on the higher dimension feature zᵢ^{(l)} corresponding to the subject lanelet 92A and the particular local lanelet 92B that are part of the specific orientation group and the normalized shared attention mechanism aᵢⱼ^{(l)}. The transformed feature vector h*ᵢ^{(l)} is expressed in Equation 14 as:

$${h}_{i}^{* ( l )} = σ ( {Σ}_{j ∈ 𝒩 ( i )} {a}_{ij}^{( l )} {z}_{i}^{( l )} ) \qquad Equation 14$$

where σ represents a nonlinear transform function.

The classifier 68 then fuses the transformed feature vector h*ᵢ^{(l)} for the subject lanelet 92A and each local lanelet 92B together to determine a single fused feature vector hᵢ⁽ⁱ⁺¹⁾, where the single fused feature vector hᵢ⁽ⁱ⁺¹⁾ is input to build a subsequent layer of the neural network 120 (FIG. 2).]]. In one embodiment, the transformed feature vector h*ᵢ^{(l)} for each lanelet 92B, including the subject lanelet, can be concatenated to determine a single feature vector hᵢ⁽ⁱ⁺¹⁾. Equations 15 and 16 may be used to determine the single fused feature vector hᵢ⁽ⁱ⁺¹⁾, and are expressed as:

$${h}_{i}^{( i + 1 )} = {‖}_{k = 0}^{3} {h}_{i}^{* ( l )} \qquad Equation 15$$

$${h}_{i}^{( i + 1 )} = {D}^{( l )} \cdot ( {‖}_{k = 0}^{3} {h}_{i}^{* ( l )} ) \qquad Equation 16$$

where D^{(l)} represents a vector or trainable parameter having the same length as the single fused feature vector hᵢ⁽ⁱ⁺¹⁾.

Referring back to FIG. 2, once the neural network 120 is built, the classifier 68 then trains the neural network 120 based on the training data 52 received from the ground truth mapper 58 of the ground truth generation module 42 as well as the simulated data 54 injected with the noise 72 and occlusion features 74 by an occlusion and noise block 64. FIG. 7 is a process flow diagram illustrating an exemplary method 200 for training the neural network 120 shown in FIG. 2. Referring generally to FIGS. 1-7, the method 200 may begin in block 202. In block 202, the one or more controllers 20 receive the 54 simulated data, where the simulated data 54 is a combination of the map data 26 and simulated perception data 48. The method 200 may then proceed to blocks 204 and 206. It is to be appreciated that block 204 may be performed simultaneously with blocks 206 and 208.

In block 204, the annotation block 56 of the ground truth generation module 42 combines the simulated data 54 with the manual annotations 59 to create a labeled training data set, which is referred to as the ground truth data set 60 (FIG. 2). The method 200 may then proceed to block 210, which is described below after block 208.

In block 206, the occlusion and noise block 64 introduces the noise 72 to the simulated data 54 received from the simulator 50. As mentioned above, the noise 72 is modeled to represent variation and error that are observed with real-world map and perception data. Additionally, or in the alternative, the occlusion and noise block 64 of the training module 44 determines the occlusion features 74 based on a mask 110 (FIG. 5B) representing an occluded region 104 along a roadway 100. The method 200 may then proceed to block 208.

In block 208, the segmentation block 66 receives the simulated data 54 that has been injected with the noise 72 and occlusion features 74 and identifies the lanelets 92 of the lane graph structure 90 (FIG. 4), where the lane graph structure 90 is included as part of the noisy lanelet training samples 62. It is to be appreciated that block 208 is optional, and in some embodiments the simulated data 54 may not be injected with the noise and occlusion features 74. The method 200 may then proceed to block 210.

In block 210, the ground truth mapper 58 determines the training data 52 by mapping the one or more groups of labeled ground truth data points GTᵢ to the one or more groups of perturbed lane edge points SEGⱼ of the noisy lanelet training samples 62 that have been displaced from the original group of labeled ground truth data points GTᵢ to another group of labeled ground truth data points GTᵢ that are part of the ground truth data set 60. As mentioned above, the noisy lanelet training samples 62 are displaced by the noise 72 and the occlusion features 74 introduced into the simulated data 54 at the occlusion and noise block 64. The method 200 may then proceed to block 212.

In block 212, the classifier 68 trains the neural network 120 to classify each lanelet 92 of the lane graph structure 90 (FIG. 4) based on the training data 52 from the ground truth mapper 58 and the noisy lanelet training samples 62 received from the segmentation block 66. Each lanelet 92 is classified based on one or more lane attributes, where the lane attributes represent one or more permitted maneuvers associated with each lanelet 92. The method 200 may then proceed to decision block 214.

In decision block 214, in response to determining the neural network 120 of the classifier is completely trained, method 200 may proceed to block 216. Otherwise, the method 200 may proceed back to block 212.

In block 216, in response to determining the neural network 120 of the classifier 68 is trained, the classifier 68 evaluates the perception data 24 generated by the plurality of sensors 22 (FIG. 1) and the map data 26, where the classifier 68 is now part of the inference module 46 (FIG. 2). The method 200 may then terminate.

Referring generally to the figures, the disclosed lanelet classification system provides various technical effects and benefits. Specifically, the lanelet classification system is trained based on a limited number of annotated data samples with an unlimited number of simulation examples. This reduces the number of real-world data samples that are collected and require manual labeling, which may become cumbersome and time consuming for an individual to complete. The disclosed lanelet classification system also utilizes noise and occlusion features, which mimic real-world variations within the map and perception data. The disclosure also provides an approach for building a neural network that classifies the lanelets as well.

The controllers may refer to, or be part of an electronic circuit, a combinational logic circuit, a field programmable gate array (FPGA), a processor (shared, dedicated, or group) that executes code, or a combination of some or all of the above, such as in a system-on-chip. Additionally, the controllers may be microprocessor-based such as a computer having a at least one processor, memory (RAM and/or ROM), and associated input and output buses. The processor may operate under the control of an operating system that resides in memory. The operating system may manage computer resources so that computer program code embodied as one or more computer software applications, such as an application residing in memory, may have instructions executed by the processor. In an alternative embodiment, the processor may execute the application directly, in which case the operating system may be omitted.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A lanelet classification system for an autonomous vehicle, the lanelet classification system comprising:
one or more controllers including a classifier having a neural network that classifies lanelets of a lane graph structure based on one or more lane attributes, the one or more controllers executing instructions to build the neural network by:
determining a higher dimension feature for a plurality of local lanelets and a subject lanelet, wherein a spatial relationship exists between the subject lanelet and the local lanelets;
computing an attention score for each of the local lanelets based on the higher dimension feature, wherein the attention score indicates a weight value that the subject lanelet has on a particular local lanelet;
determining a normalized shared attention mechanism applicable to all of the local lanelets based on the attention score;
computing a transformed feature vector of the local lanelet based on the higher dimension feature and the normalized shared attention mechanism; and
fusing the transformed feature vector for each of the local lanelet together to determine a single fused feature vector, wherein the single fused feature vector is input to build a subsequent layer of the neural network.

2. The lanelet classification system of claim 1, wherein the spatial relationship indicates an upstream, downstream, left, and right relationship between the subject lanelet and the local lanelets.

3. The lanelet classification system of claim 1, wherein the higher dimension feature is determined based on:
$${z}_{i}^{( l )} = {W}^{( l )} {h}_{i}^{( l )}$$
wherein zᵢ^{(l)} is the higher dimension feature, hᵢ^{(l)} represents a set of node features that represent a summarization of local attributes of the local lanelets and the subject lanelet, and W^{(l)} represents a weight matrix.

4. The lanelet classification system of claim 1, wherein the attention score is computed based on a nonlinear activation function.

5. The lanelet classification system of claim 1, wherein the normalized shared attention mechanism is determined based on a normalization function that sums to 1.

6. The lanelet classification system of claim 1, wherein the transformed feature vector is determined based on:
$${h}_{i}^{* ( l )} = σ ( {Σ}_{j ∈ 𝒩 ( i )} {a}_{i j}^{( l )} {z}_{i}^{( l )} )$$
wherein h*ᵢ^{(l)} represents the transformed feature vector, zᵢ^{(l)} is the higher dimension feature, N₍ᵢ₎ represents a neighborhood of the particular local lanelet i, aᵢⱼ^{(l)} represents the normalized shared attention mechanism, and σ represents a nonlinear transform function.

7. The lanelet classification system of claim 1, wherein the single fused feature vector is determined based on:
$${h}_{i}^{( i + 1 )} = {D}^{( l )} \cdot ( {\vert \vert}_{k = 0}^{3} {h}_{i}^{* ( l )} )$$
wherein hᵢ⁽ⁱ⁺¹⁾ represents the single fused feature vector, D^{(l)} represents a vector having the same length as the single fused feature vector hᵢ⁽ⁱ⁺¹⁾, and h*ᵢ^{(l)} represents the transformed feature vector.

8. The lanelet classification system of claim 1, wherein the neural network of the classifier is a graph attention network.

9. A lanelet classification system for an autonomous vehicle, the lanelet classification system comprising:
one or more controllers including a classifier having a neural network that classifies lanelets of a lane graph structure based on one or more lane attributes, the one or more controllers executing instructions to:
receive simulated data, wherein the simulated data is a combination of map data and simulated perception data;
combine the simulated data with manual annotations that label the simulated perception data together to create a ground truth data set;
determine training data by mapping labels of one or more groups of labeled ground truth data points that are part of the ground truth data set to one or more groups of perturbed lane edge points that have been displaced from an original group of labeled ground truth data points to another group of labeled ground truth data points that are part of the ground truth data set; and
train the neural network to classify each lanelet of the lane graph structure based on the training data.

10. The lanelet classification system of claim 9, wherein the one or more controllers execute instructions to:
determine the neural network of the classifier is completely trained; and
in response to determining the neural network of the classifier is completely trained, evaluate perception data generated by a plurality of sensors and the map data.

11. The lanelet classification system of claim 9, wherein the one or more controllers execute instructions to:
identify an amount of overlap between a particular group of perturbed lane edge points and a particular group of labeled ground truth data points by calculating an intersection-over-union evaluation metric.

12. The lanelet classification system of claim 11, wherein the one or more controllers execute instructions to:
calculate the intersection-over-union evaluation metric based on:
$$IOU = \frac{\vert \{ P \vert P ∈ {GT}_{i} ⋂ {SEG}_{j} \} \vert}{\vert \{ P \vert P ∈ {GT}_{i} ⋃ {SEG}_{j} \vert}$$
wherein IOU is the intersection-over-union evaluation metric, SEGⱼ represents a particular group of perturbed lane edge points, GTᵢ represents a particular group of labeled ground truth data points, and P represents lane edge points expressed as a unique identification (ID) numbers.

13. The lanelet classification system of claim 9, wherein the one or more controllers execute instructions to:
introduce noise to the simulated data to create noisy lanelet training samples.

14. The lanelet classification system of claim 13, wherein the noise is modeled based on a variance profile of an error in a lane edge of the lane graph structure and a covariance.

15. The lanelet classification system of claim 14, wherein the error in the lane edge is modeled as a Gaussian Process, and wherein a kernel function models a spatial correlation of the error between two lane edge points.

16. The lanelet classification system of claim 14, wherein a Matern 3/2 kernel function determines the variance profile.

17. The lanelet classification system of claim 14, wherein the covariance is determined based on:
$$Σ = {S}^{1 / 2} {CS}^{1 / 2}$$
wherein Σ is the covariance, C is a correlation matrix, and S is a diagonal scale matrix.

18. The lanelet classification system of claim 9, wherein the one or more controllers execute instructions to:
introduce occlusion features to the simulated data, wherein the occlusion features represent an occluded region of a roadway that the autonomous vehicle is traveling along.

19. A lanelet classification system for an autonomous vehicle, the lanelet classification system comprising:
a plurality of sensors collecting perception data indicative of an environment surrounding the autonomous vehicle; and
one or more controllers in electronic communication with the plurality of sensors, wherein the one or more controllers include a classifier having a neural network that classifies lanelets of a lane graph structure based on one or more lane attributes, the one or more controllers executing instructions to:
receive simulated data, wherein the simulated data is a combination of map data and simulated perception data;
combine the simulated data with manual annotations that label the simulated perception data together to create a ground truth data set;
introduce noise and occlusion features to the simulated data to create noisy lanelet training samples;
determine training data by mapping labels of one or more groups of labeled ground truth data points that are part of the ground truth data set to one or more groups of perturbed lane edge points the noisy lanelet training samples that have been displaced from an original group of labeled ground truth data points to another group of labeled ground truth data points that are part of the ground truth data set;
train the neural network to classify each lanelet of the lane graph structure based on the training data and the noisy lanelet training samples;
determine the neural network of the classifier is completely trained; and
in response to determining the neural network of the classifier is completely trained, evaluate perception data generated by a plurality of sensors and the map data.

20. The lanelet classification system of claim 19, wherein the one or more controllers execute instructions to:
identify an amount of overlap between a particular group of perturbed lane edge points and a particular group of labeled ground truth data points calculating an intersection-over-union evaluation metric.
